(19) United States
(12) Patent Application Publication
(10) Pub. No.: US 2024/0335270 A1
(43) Pub. Date: Oct. 10, 2024

(54) Radiolucent Veterinary Positioning Devices

(71) Applicant: Techno-Aide, Inc., Whites Creek, TN (US)

(72) Inventors: Aaron Scalf, Hendersonville, TN (US); Devin Mahoney, Hendersonville, TN (US)

(73) Assignee: Techno-Aide, Inc., Whites Creek, TN (US)

(21) Appl. No.: 18/296,370

(22) Filed: Apr. 5, 2023

(51) Int. Cl. A61D 3/00

(52) U.S. Cl. CPC A61D 3/00; A61G 2210/50

(57) ABSTRACT

A positioning device for positioning and securing an animal during imaging or surgical procedures comprising a body portion, the body portion comprising a closed-cell foam to thereby provide a highly radiolucent, cleanable and re-usable positioning device. The foam can be a cross-link foam. The body portion comprises a support portion and a trough portion above the support portion for retaining an animal in a trough opening of the positioning device. The trough portion comprises opposing wedge members having angled support walls. In embodiments, the trough is substantially V-shaped, while in others the trough has a flat surface. The angled support walls form a trough angle of selected degrees.

### CROSS REFERENCE TO RELATED APPLICATIONS

Not applicable

### FIELD OF THE INVENTION

The present invention relates to surgery on animals, and more particularly to devices for use in securely positioning animals during imaging and surgical procedures.

### BACKGROUND OF THE INVENTION

During imaging and surgical procedures on an animal, such as a pet, it is necessary to sedate and secure the animal in a desired position for the procedure. Positioning devices exist for use in positioning animals during procedures. However, these devices suffer from numerous drawbacks.

Current positioning devices, such as the device shown in FIG. 1, are made of plastic coated or vinyl covered open-cell foam. However, open-cell foam suffers from several drawbacks when used for veterinary positioning devices. Open-cell foam is porous. Consequently, open-cell foam absorbs liquids and stains easily. Biofluids and other compounds are retained in the open cells, making such devices difficult to clean and thus difficult or impossible to safely re-use for surgical procedures.

In the embodiment, of FIG. 1, the open cell foam body is covered with a vinyl cover. However, the cover adds costs and cannot ensure that biofluids and other compounds will remain segregated from the open-cell foam if the cover is penetrated, torn, clawed, bitten, or damaged in any other manner, allowing exposure to the open-cell foam underneath due to the nature of veterinary medicine. Since the device cannot be reused if there is exposure of biofluids to the open-cell foam, large quantities of devices are purchased and thrown away after single use. This increases expenses for veterinary care, increases waste, and is harmful for the environment.

Additionally, vinyl covered and plastic coated open-cell foam causes artifacting when used under x-ray imaging and therefore disrupts the image. This makes it difficult to get acceptable X-ray images of an animal positioned on a vinyl covered open-cell foam positioning device.

There is a need for a positioning device that overcomes the above disadvantages of prior art positioning devices.

### OBJECTS AND SUMMARY OF THE INVENTION

It is an object of the inventions to provide a positioning device for surgery and imaging procedures on animals that does not absorb liquids, is easy to clean, is reusable and does not disrupt x-ray images.

It is an object of the inventions to provide a positioning device for surgery and imaging procedures on animals that is highly radiolucent and artifact free for improved imaging of animals when positioned on the device.

It is an object of the inventions to provide a positioning device for surgery and imaging procedures on animals that is comfortable, lightweight, and extremely durable.

The foregoing objectives are achieved by providing a veterinary positioning device having the features described herein.

In embodiments, the invention is a positioning device for positioning and securing an animal during imaging or surgical procedures. In embodiments, the positioning device comprises a body portion, the body portion comprising a closed-cell foam to thereby provide a highly radiolucent, cleanable and re-usable positioning device. The body portion comprises a support portion and a trough portion above the support portion, the trough portion sized and configured to retain an animal in a trough opening of the positioning device during imaging or surgical procedures. The support portion comprises a substantially planar bottom side, a top side, a first support side and an opposing second support side.

The trough portion comprises a first wedge member above the first support side and a second wedge member above the second support side. The first wedge member has a first outer sidewall extending upward along the first support side, and a first interior support wall angled down to a base of the trough portion. The second wedge member has a second outer sidewall extending upward along the second support side, and an interior support wall angled down to the base of the trough portion. The first angled support wall and the second angled support wall together form a substantially a centralized trough opening configured for positioning and securing an animal.

In embodiments, the closed-cell foam is a cross-link foam.

In embodiments, the body portion is a unibody structure formed from a single block of foam. In other embodiments, the unibody structure is formed from a plurality of individual closed-cell foam components, the individual closed-cell foam components fixedly secured together.

In embodiments, the trough is substantially V-shaped. The first and the second angled support walls form a trough angle, the trough angle being between about 80 to about 100 degrees. In embodiments, the trough angle is about 85 degrees.

In embodiments, the base of the trough portion is a flat surface spaced between the first and second angled support walls. In this embodiment, the first and the second angled support walls form a trough angle, the trough angle being between about 85 to about 105 degrees. In embodiments, the trough angle is about 98 degrees, such 98.35 degrees.

In embodiments, the body portion is not enclosed in a coating or covering, the closed-cell foam being sufficiently impermeable to render a coating or covering unnecessary.

Methods of using the device for imaging of animals for veterinary procedures are also provided.

The foregoing and other objects, features, aspects and advantages of the invention will become more apparent from the following detailed description of the invention when considered in conjunction with the accompanying drawings.

### BRIEF DESCRIPTION OF THE DRAWINGS

FIG. 1 is a perspective view of a prior art positioning device with a sedated animal secured in the device.

FIG. 2A is one embodiment of a positioning device of the invention prior to positioning an animal on the device, and further showing accessory components.

FIG. 2B shows the embodiment of FIG. 2A with a sedated animal positioned in the positioning device.

FIG. 2C shows the embodiment of FIG. 2A with a sedated animal positioned and secured in the positioning device.

FIG. 3A is a side perspective view of one embodiment of a positioning device, featuring a flat section.

FIG. 3B is a top view of the embodiment of FIG. 3A.

FIG. 3C is a side view of the embodiment of FIG. 3A, showing a flat bottom section and a selected trough angle.

FIG. 3D is a side view of the embodiment of FIG. 3A.

FIG. 4A is a side perspective view of one embodiment of a positioning device, featuring a V-trough.

FIG. 4B is a top view of the embodiment of FIG. 4A.

FIG. 4C is a side view of the embodiment of FIG. 4A, showing a selected trough angle.

FIG. 4D is a side view of the embodiment of FIG. 4A.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

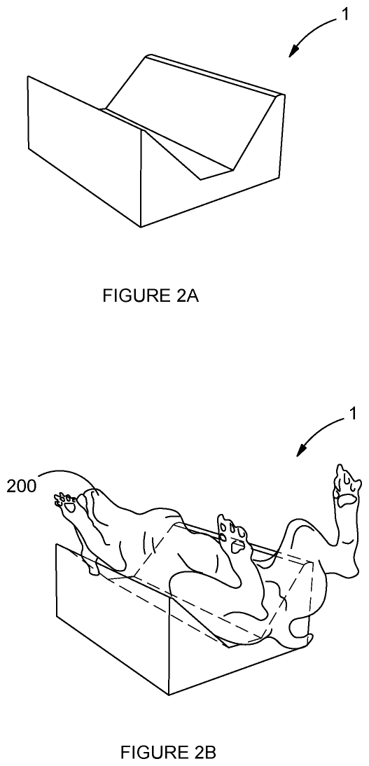

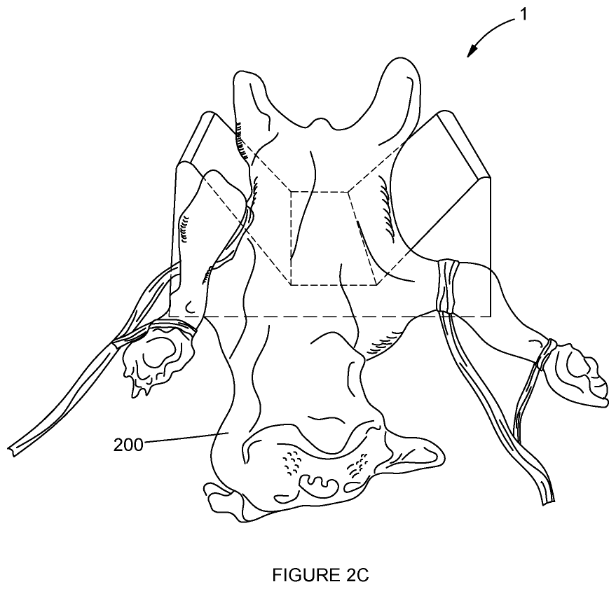

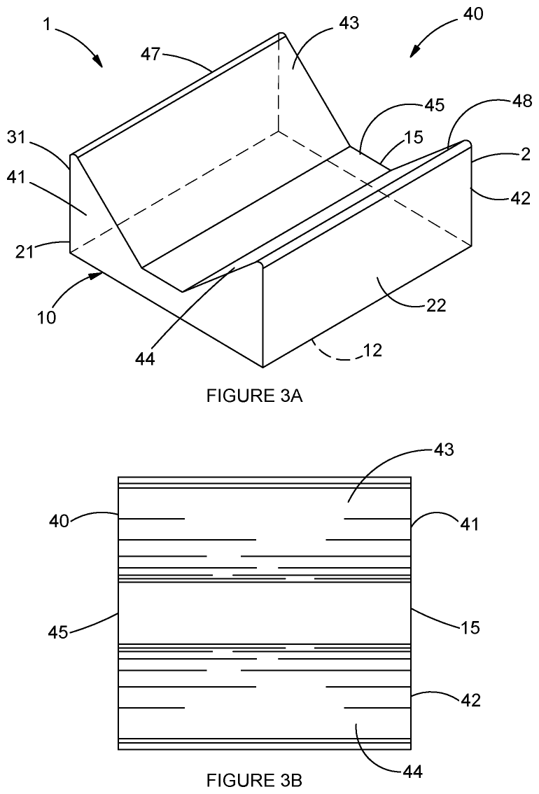

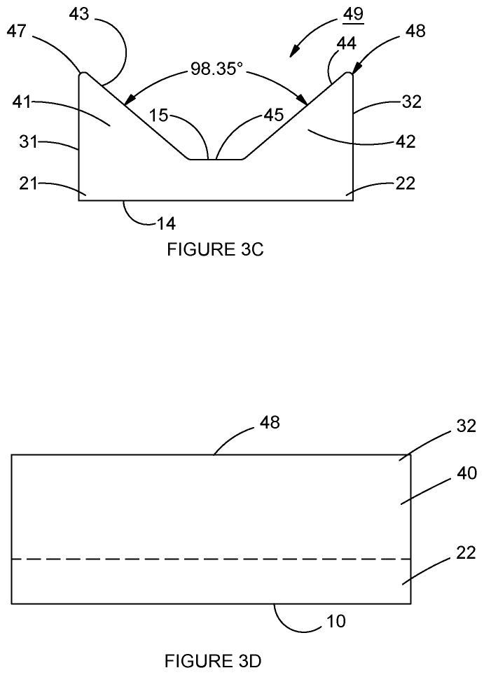

The positioning device 1 of the invention is configured for use as a veterinary or pet positioning device 1. FIGS. 2A-2C provide a high-level overview of embodiments of the positioning device 1 in use to position and secure an animal 200 during imaging or surgical procedures. As can be seen in FIGS. 2A-2C, the positioning device 1 has a generally trough-like configuration for use in immobilizing and securing animals 200 for imaging and surgical procedures. As seen in the detailed view of FIG. 3A, the positioning device 1 comprises, generally, a body portion 2, the body portion 2 comprising, consisting of, or essentially consisting of a closed-cell foam 100. In embodiments, the closed-cell foam 100 is a cross-link foam. While the body portion 2 can be formed of foams of various densities and indentation force deflection (IFD), in embodiments, the cross-link foam has a density of between about 1.0 to about 3 lbs./ft², such as 1.5 lbs./ft², and an indentation force deflection (IFD) of between about 35 and about 50, such as 42. In embodiments, the type of foam is a cross linked polyethylene (XLPE) foam having a density of about 2.0 lbs./ft².

The closed-cell foam 100 provides and ensures a highly radiolucent, artifact-free, cleanable and re-usable positioning device 1. As described in further detail herein, the body portion 2 comprises, generally, a support portion 10 and a trough portion 40 above the support portion 10. The trough portion 40 is sized and configured to retain an animal 200 in a trough opening 49 of the positioning device 1.

In FIG. 2A, the positioning device 1 is shown empty, prior to positioning an animal 200 in the device 1. Accessory components such as supplemental wedges, lifters and straps can be used with the positioning device. The wedges and lifters can be made of the same closed-cell foam 100 as the positioning device 1. In FIG. 2B, a sedated animal 200 is shown positioned in the positioning device. In FIG. 2C, a sedated animal 200 is shown secured in the positioning device 1 using straps.

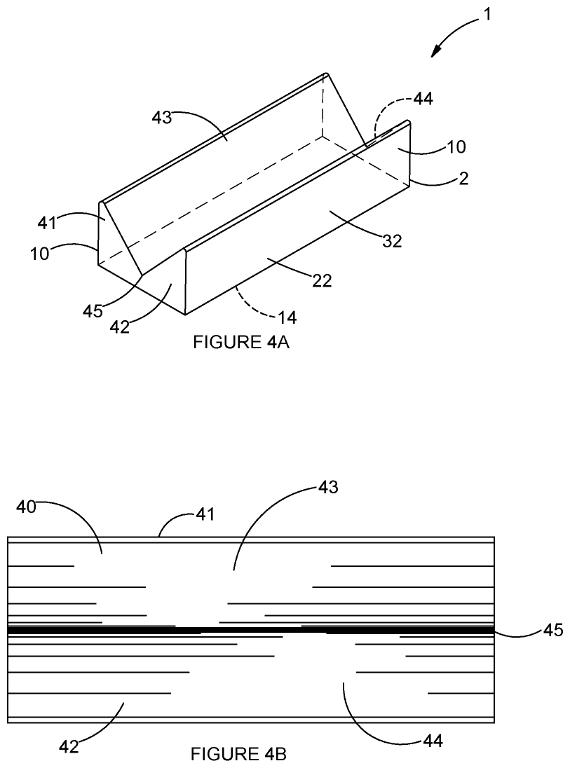

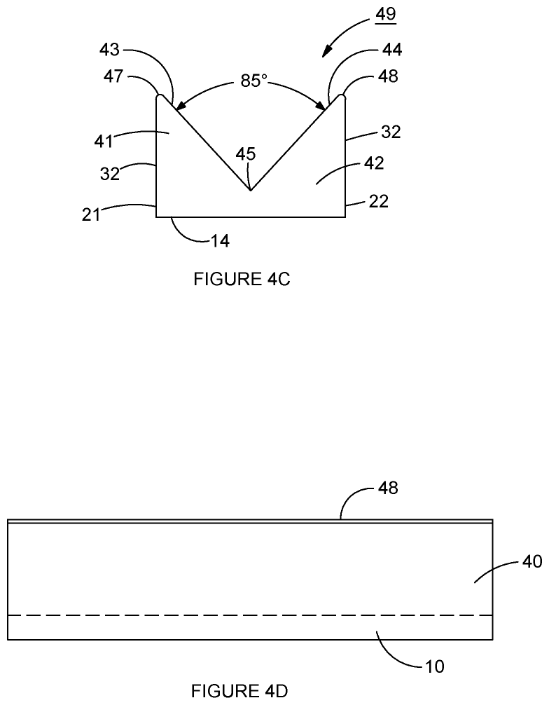

As shown in the detailed view of FIGS. 3A-3D and 4A-4D, the positioning device 1 is typically a unibody structure, either cut from or molded into a single body of foam 100. However, for certain embodiments and uses, the unibody structure can be formed from a plurality of individual closed-cell foam components, the individual closed-cell foam components fixedly secured together. The foam may be glued together to achieve the necessary product height. In this embodiment the glue seam must be parallel to the imaging field to maintain the artifact free imaging field.

Details of the positioning device 1 will now be described with reference to FIGS. 3A-3D. As can be seen in FIG. 3A, the support portion 10 includes a substantially planar bottom side 12, a top side 15, a first support side 21 and an opposing second support side 22. A trough portion 40 is provided above the support portion 10. The trough portion 40 is provided by a first wedge member 41 above the first support side 21 and a second wedge member 42 above the second support side 22. FIG. 3D provides a side view further showing the relationship between the support portion 10 and the trough portion 40.

As can be seen in the sideview of FIG. 3C and FIG. 4C, the first wedge member 41 has a first outer sidewall 31 extending upward along the first support side 21 and a first interior support wall 43 angled down to a base 45 of the trough portion 40. The second wedge member 42 has a second outer sidewall 32 extending upward along the second support side 22 and an interior support wall 43 angled down to the base 45 of the trough portion 40. In the embodiment of FIG. 3C, the first interior support wall 43 extends down from a top 47 of first outer sidewall 31, while the second interior support wall 44 extends down from a top 48 of first outer sidewall 32. As can be seen in FIG. 3C, the first angled support wall 43 and the second angled support wall 44 together form a substantially centralized trough opening 49 configured for positioning and securing the animal 200. The trough opening 49 is preferably centralized or substantially centralized on the positioning device 1, as indicated in FIGS. 3C and 4C.

With reference to FIG. 3C, in embodiments, the base 45 of the trough portion 40 is a flat surface 15 spaced between the first and second angled support walls 43, 44. In the embodiment of FIG. 3C, the flat base 45 is formed by the top side 15 of the support portion 10. The flat base 45 configuration is useful for larger animals 200, such as medium to large dogs. As can be seen in FIG. 3C, the first and the second angled support walls 43, 44 form a trough angle.

In a flat-trough embodiment, the trough angle can be between about 85 to about 105 degrees. In embodiments, the trough angle is about 98 degrees, and ideally 98.35 degrees. A flat bottom embodiment exists for a different position for imaging versus the V-trough embodiment. A flat bottom better places the animal's hips when the animal is lying on its back, depending upon the type of imaging required. It is believed that flat surface embodiments do not exist in the prior art and that the use of closed-cell foam facilitates the formation or enables the use of a flat surface 15 embodiment. For example, with a closed-cell foam positioning device 1, a separate cover sized and shaped to the configuration of the foam is unnecessary.

In contrast, FIGS. 4A-4D show an embodiment in which the trough is substantially V-shaped. The V-shaped configuration is useful for smaller animals 200, such as cats and small dogs. In V-shape embodiments, the trough angle can be between about 80 to about 100 degrees. In some embodiments, the trough angle is about 85 degrees.

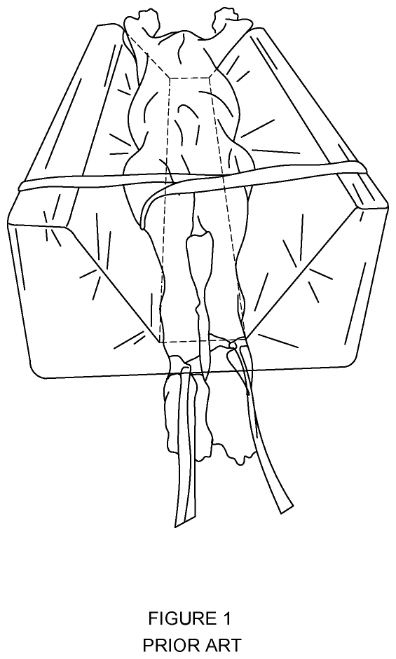

As can be appreciated, unlike prior art embodiments such as FIG. 1, the body portion 2 of the positioning device 1 of the invention is not enclosed in a coating or covering, the closed-cell foam 100 providing sufficiently impermeable to render a coating or covering unnecessary.

The unique V-shaped configuration of the positioning device 1 reduces motion of the animal 200. This reduces the risk of falls during a variety of procedures.

The positioning sponges are entirely fluid resistant, easy to clean and extremely durable. In embodiments, the positioning sponge 1 is featured in a non-coated, premium charcoal grey color.

In order to accommodate a range of patient sizes, the positioning sponges may be provided in a range of sizes and configurations. In embodiments, the positioning sponges 1 are provided in four sizes, which can be generally characterized as small, medium, large and extra-large. As examples of sizing, in one embodiment, a V-shaped positioning device is about 36 inches long, about 14 inches wide, about 8 inches high, and has a support portion 10 that is about 2 inches high. In one embodiment, a flat-bottom positioning device is about 15 inches long, 14 inches wide, about 6.5 inches in height, and has support portion 10 that is about 2 inches high. The different sizes can be sold individually, or different sizes can be sold as a bundle for quick and simple purchasing.

In embodiments, the positioning device 1 is highly radiolucent and provides artifact free x-ray imaging. Highly radiolucent or high radiolucency means an optical density of between about 0.1 to about 0.5 on a standardized x-ray image, or a grayscale value of 30 to about 60 on a digital x-ray image.

The closed cell foam material 100 provides a positioning device 1 that has an easily cleanable, fluid resistant surface. Consequently, the device 1 is easy and safe to clean with standard germicides and mild cleaners. This eliminates the need for an expensive spray-on coating or a vinyl cover.

In use, the positioning device 1 is used by positioning an animal 200 in the trough, such as is shown in FIG. 2B or 2C. The animal 200 is positioned according to the desired type of X-ray or other imaging procedure, using various positions that are known in the art in order to obtain a desired image for particular conditions or injuries. However, the device 1 provides highly radiolucent images. Additionally, after completion of the imaging procedure, the device 1 can be readily cleaned, sanitized and reused in a subsequent procedure. Re-use can be continued in successive procedures until the device 1 becomes worn, torn or otherwise unusable, thus significantly increasing the useable life of the device relative to prior art devices such as the vinyl covered device of FIG. 1. In embodiments, the device can preferably be reused in over one hundred imaging procedures. While the useful life of a particular positioning device 1 will depend on many factors, it is anticipated that the devices 1 will last for years under ordinary circumstances. One advantage of using a closed-cell, non-porous foam is that normal tears or abrasions on the surface of the device do not render it unusable because the surface remains non-porous. With prior art covered devices such as the device depicted in FIG. 1, a scratch or an animal bite that pierces the vinyl renders the device unusable because liquids can seep into the open cell foam.

The positioning device 1 is configured to be comfortable, lightweight, and extremely durable. The positioning devices 1 are ideal for hands-free veterinary imaging. The design virtually eliminates the need for dangerous, costly, and time-consuming reshoots, and supports the ALARA (As Low As Reasonably Achievable) principle of radiation safety.

With the flat bottom and V-shaped configurations described herein, veterinary facilities can easily achieve a wide variety of patient positions that are critical for veterinary radiography, such as: ventrodorsal view, rostral caudal open mouth tympanic bullae view, rostral caudal frontal sinus view, rostral caudal occipital view, rostral caudal open mouth maxilla view, caudocranial shoulder view, straight VD projections of the abdomen and thorax, or general pelvis, hip, and spine radiographs, and many more. The unique V-shape configuration helps obtain key positioning of the animal during veterinary radiography. The V-shape design also reduces motion of the animal and the risk of falls.

Manufacturing the positioning device 1 out of closed-cell foam 100 provides many benefits. Benefits of closed-cell foam versus open-cell foam options are that they are non-porous, radiolucent, and cleanable for repeated use. This solves various problems with prior art positioning devices formed of open-cell foam including porosity, radiopaque, and inability to be cleaned sufficiently to remove bioburden and other contamination, and thus cannot be reused safely. Positioning devices of the invention 1 also sell for a lower price point than a comparable device that is reusable. The combination of all these factors gives the positioning device 1 a unique place in the market.

The positioning device 1 can be provided as part of a kit. The components of the kit can be arranged in a convenient format, such as in a surgical tray or case. However, the kit components do not have to be packaged or delivered together, provided that they are assembled or collected together in the operating room for use at the time of use.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A positioning device for positioning and securing an animal during imaging or surgical procedures comprising:
a body portion, the body portion comprising a closed-cell foam to thereby provide a highly radiolucent, cleanable and re-usable positioning device,
the body portion comprising a support portion and a trough portion above the support portion, the trough portion sized and configured to retain said animal in a trough 9 opening of the positioning device,
the support portion comprising a substantially planar bottom side, a top side, a first support side and an opposing second support side,
the trough portion comprising
a first wedge member above the first support side,
a second wedge member above the second support side,
the first wedge member having a first outer sidewall extending upward along the first support side, and a first interior support wall angled down to a base of the trough portion,
the second wedge member having a second outer sidewall extending upward along the second support side, and an interior support wall angled down to the base of the trough portion, and
the first angled support wall and the second angled support wall together forming a substantially a centralized trough opening configured for positioning and securing said animal.

2. The positioning device of claim 1, wherein the closed-cell foam is a cross-link foam.

3. The positioning device of claim 1, wherein the body portion is a unibody structure.

4. The positioning device of claim 1, wherein the unibody structure is formed from a plurality of individual closed-cell foam components, the individual closed-cell foam components fixedly secured together.

5. The positioning device of claim 1, wherein the trough is substantially V-shaped.

6. The positioning device of claim 5, wherein the first and the second angled support walls form a trough angle, the trough angle being between about 80 to about 100 degrees.

7. The positioning device of claim 6, wherein the trough angle is about 85 degrees.

8. The positioning device of claim 1, wherein the base of the trough portion is a flat surface spaced between the first and second angled support walls.

9. The positioning device of claim 8, wherein the first and the second angled support walls form a trough angle, the trough angle being between about 85 to about 105 degrees.

10. The positioning device of claim 9, wherein the trough angle is about 98 degrees.

11. The positioning device of claim 10, wherein the trough angle is 98.35 degrees.

12. The positioning device of claim 1, wherein the body portion is not enclosed in a coating or covering, the closed-cell foam being sufficiently impermeable to render a coating or covering unnecessary.
